(19) United States
(12) Patent Application Publication
(10) Pub. No.: US 2023/0029320 A1
(43) Pub. Date: Jan. 26, 2023

(54) METHODS AND APPARATUS FOR OPTIMIZING HYPERPARAMETER SEARCH FUNCTIONALITY

(71) Applicant: Walmart Apollo, LLC, Bentonville, AR (US)

(72) Inventors: Chepuri Shri Krishna, Annanagar (IN); Swarnim Narayan, Bangalore (IN); Himanshu Rai, Bangalore (IN); Diksha Manchanda, Doddanekundi (IN)

(21) Appl. No.: 17/378,581

(22) Filed: Jul. 16, 2021

(51) Int. Cl. G06K 9/62; G06N 20/00

(52) U.S. Cl. CPC G06K 9/6262; G06K 9/6228; G06K 9/6232; G06N 20/00

(57) ABSTRACT

A system can implement, in a first hyperparameter configuration state, a first set of hyperparameter search operations. The first set of hyperparameter search operations includes selecting a first set of hyperparameters. Each hyperparameter of the first set of hyperparameters having a corresponding configuration. Additionally, the first set of hyperparameter search operations includes obtaining a first set of performance data that includes information indicating a performance of each hyperparameter of the first set of hyperparameters, and assigning a value to each hyperparameter of the first set of hyperparameters based on the corresponding performance data.

### TECHNICAL FIELD

The disclosure relates generally to apparatus and methods for optimizing hyperparameter search functionality of a models, such as a machine learning model.

### BACKGROUND

Machine learning models use parameters, known as hyperparameters, to control the learning process. For example, hyperparameters may control constraints, weights, algorithms, learning rates, or other features associated with a machine learning model. The use of particular hyperparameters by a machine learning model may affect the machine learning model's performance. As such, before executing a machine learning model, hyperparameters for a machine learning model are typically first selected and tuned. Some current approaches for hyperparameter optimization include Manual Search, Grid Search, Random Search, and Bayesian Optimization.

Machine learning models are used across a variety of applications. For instance, machine learning models may be used determine search results in response to a search request. For example, at least some websites, such as retailer websites, allow a visitor to search for items. The website may include a search bar that allows the visitor to enter search terms, such as one or more words, that the website uses to search for items. In response to entering in the search terms, a computing device may execute a machine learning model to determine search results based on the entered search terms. The website may then display the search results, such as items for sale.

The relevancy of search results, however, is at least partially based on the performance of the executed machine learning model. For example, a machine learning model operating with more optimum hyperparameters may produce more relevant search results than another machine learning model operating with less optimum hyperparameters. As such, there are opportunities to improve hyperparameter optimization techniques when using machine learning models across a variety of applications, such as to determine search results.

### SUMMARY

The embodiments described herein are directed to automatically determining hyperparameters for machine learning models. The apparatus and methods described herein may be applied to hyperparameter selection for machine learning models used across a variety of applications, such as to machine learning models that determine search results in response to a search request. The apparatus and methods described herein may improve upon current hyperparameter optimization techniques by identifying more optimum hyperparameters for a machine learning model. In some instances, the apparatus and methods described herein may allow for the consumption of less processing time to identify the hyperparameters for a machine learning model when compared to conventional techniques. Moreover, the apparatus and methods described herein may be resilient to variations in learning rates. For example, they may allow for higher performing (e.g., more accurate and precise) machine learning models across learning rates compared to conventional techniques. Additionally, the apparatus and methods described herein may be useful in a low computational resource setting, such as a budget, while being easily scalable for a large computational resource setting for discovering computational architectures.

In accordance with various embodiments, exemplary computing systems may be implemented in any suitable hardware or hardware and software, such as in any suitable computing device. In some embodiments, a computing device executes a hyperparameter determination model, while in a first hyperparameter configuration state, to implement a first set of hyperparameter search operations. The first set of hyperparameter search operations can include selecting a first set of hyperparameters. In some examples, the first set of hyperparameters can be selected from a pool of hyperparameters. Additionally, the hyperparameter search operations can include obtaining performance data that includes information, such as a score or value, that indicates a performance of each hyperparameter of the first set of hyperparameters. In various implementations, the computing device may configure a machine learning model with the first set of hyperparameters to determine a performance of each hyperparameter of the first set of hyperparameters. Additionally, the computing device may generate such performance data. Moreover, the hyperparameter search operations can include assigning a value to each hyperparameter of the first set of hyperparameters based on the corresponding performance data.

In some embodiments, the computing device can change the hyperparameter configuration state of the hyperparameter determination model based on the assigned value of each hyperparameter of the first set of hyperparameters. Further, the computing device may execute the hyperparameter determination model, while the hyperparameter determination model is in a changed or a second configuration state to implement a second set of hyperparameter search operations.

In some embodiments, a method is provided that includes executing a hyperparameter determination model, while in a first hyperparameter configuration state, to implement a first set of hyperparameter search operations. The first set of hyperparameter search operations can include selecting a first set of hyperparameters. In some examples, the first set of hyperparameters can be selected from a pool of hyperparameters. Additionally, the hyperparameter search operations can include obtaining performance data that includes information, such as a score or value, that indicates a performance of each hyperparameter of the first set of hyperparameters. In various implementations, the method may include configuring a machine learning model with the first set of hyperparameters to determine a performance of each hyperparameter of the first set of hyperparameters, and generate such performance data. Moreover, the hyperparameter search operations can include assigning a value to each hyperparameter of the first set of hyperparameters based on the corresponding performance data.

In some embodiments, the method can include changing the hyperparameter configuration state of the hyperparameter determination model based on the assigned value of each hyperparameter of the first set of hyperparameters. Further, the method may include executing the hyperparameter determination model, while the hyperparameter determination model is in a changed or a second configuration state, to implement a second set of hyperparameter search operations.

In yet other embodiments, a non-transitory computer readable medium has instructions stored thereon, where the instructions, when executed by at least one or more processors, cause a computing system to execute a hyperparameter determination model, while in a first hyperparameter configuration state, to implement a first set of hyperparameter search operations. The first set of hyperparameter search operations can include selecting a first set of hyperparameters. In some examples, the first set of hyperparameters can be selected from a pool of hyperparameters. Additionally, the hyperparameter search operations can include obtaining performance data that includes information, such as a score or value, that indicates a performance of each hyperparameter of the first set of hyperparameters. In various implementations, the computing system may configure a machine learning model with the first set of hyperparameters to determine a performance of each hyperparameter of the first set of hyperparameters. Additionally, the computing system may generate such performance data. Moreover, the hyperparameter search operations can include assigning a value to each hyperparameter of the first set of hyperparameters based on the corresponding performance data.

In some embodiments, the computing system can change the hyperparameter configuration state of the hyperparameter determination model based on the assigned value of each hyperparameter of the first set of hyperparameters. Further, the computing system may execute the hyperparameter determination model, while the hyperparameter determination model is in a changed or a second configuration state to implement a second set of hyperparameter search operations.

### BRIEF DESCRIPTION OF THE DRAWINGS

The features and advantages of the present disclosures will be more fully disclosed in, or rendered obvious by the following detailed descriptions of example embodiments. The detailed descriptions of the example embodiments are to be considered together with the accompanying drawings wherein like numbers refer to like parts and further wherein:

FIG. 1 is a block diagram of an example hyperparameter determination system that includes a hyperparameter determination computing device;

FIG. 2 illustrates an example hyperparameter search space in accordance with some embodiments;

FIG. 3 illustrates an example architecture of hyperparameter determination model in accordance with some embodiments;

FIG. 4 illustrates a block diagram of example hyperparameter determination computing device of FIG. 1 in accordance with some embodiments;

FIG. 5 is a block diagram illustrating examples of various portions of the hyperparameter determination computing device of FIG. 1 in accordance with some embodiments;

FIG. 6 illustrates an example method that can be carried out by the hyperparameter determination computing device of FIG. 1; and

FIG. 7 illustrates another example method for can be carried out by the hyperparameter determination computing device of FIG. 1.

### DETAILED DESCRIPTION

The description of the preferred embodiments is intended to be read in connection with the accompanying drawings, which are to be considered part of the entire written description of these disclosures. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

It should be understood, however, that the present disclosure is not intended to be limited to the particular forms disclosed. Rather, the present disclosure covers all modifications, equivalents, and alternatives that fall within the spirit and scope of these exemplary embodiments. The terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship.

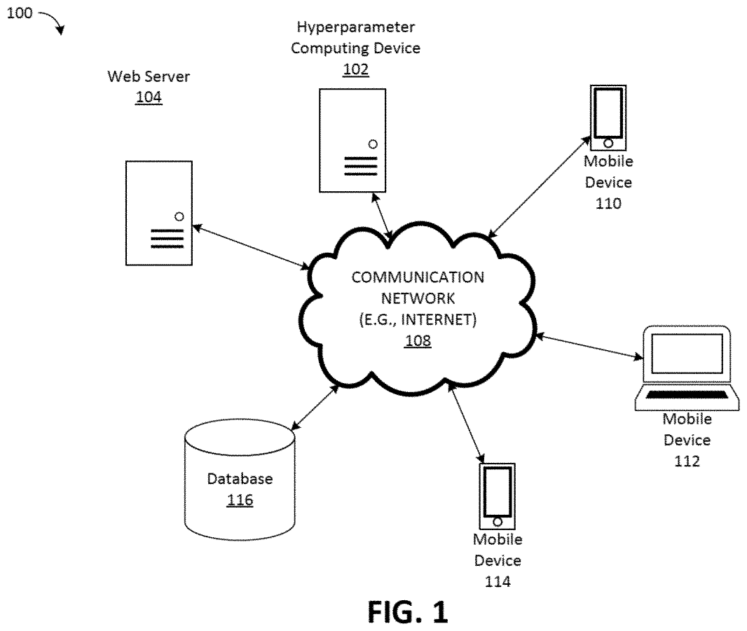

FIG. 1 illustrates a block diagram of an example hyperparameter determination system 100 that includes a hyperparameter computing device 102 (e.g., a server, such as an application server), a web server 104, database 116, and multiple customer computing devices 110, 112, 114 operatively coupled over communication network 108. Hyperparameter computing device 102, web server 104 and multiple customer mobile devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit data to, and receive data from, communication network 108.

In some examples, hyperparameter computing device 102 can be a computer, a workstation, a laptop, a server such as a cloud-based server, or any other suitable device. In some examples, each of multiple customer mobile devices 110, 112, 114 can be a cellular phone, a smart phone, a tablet, a personal assistant device, a voice assistant device, a digital assistant, a laptop, a computer, or any other suitable device. In some examples, hyperparameter computing device 102 is operated by a retailer, and multiple customer computing devices 112, 114 are operated by customers of the retailer.

Although FIG. 1 illustrates three customer mobile devices 110, 112, 114, hyperparameter determination system 100 can include any number of customer computing devices 110, 112, 114. Similarly, hyperparameter determination system 100 can include any number of hyperparameter computing device 102, web server 104, and database 116.

In some examples, web server 104 hosts one or more web pages, such as a retailer's website. Web server 104 may transmit purchase data related to orders purchased on the website by customers to hyperparameter computing device 102. Web server 104 may also transmit a search request to hyperparameter computing device 102. The search request may identify a search query provided by a customer. In response to the search request, hyperparameter computing device 102 may execute a machine learning model (e.g., algorithm) to determine search results. The machine learning model may be any suitable machine learning model, such as one based on decision trees, linear regression, logistic regression, support-vector machine (SVM), K-Means, or a deep learning model such as a neural network. The machine learning model may execute with hyperparameters selected and tuned by hyperparameter computing device 102, as described further below. Hyperparameter computing device 102 may then transmit the search results to the web server 104. Web server 104 may display the search results on the website to the customer. For example, the search results may be displayed on a search results webpage in response to the search query entered by the customer.

First customer mobile device 110, second mobile computing device 112, and N^{th} customer mobile device 114 may communicate with web server 104 over communication network 108. For example, each of multiple computing devices 110, 112, 114 may be operable to view, access, and interact with a website hosted by web server 104. In some examples, web server 104 hosts a website for a retailer that allows for the purchase of items. The website may further allow a customer to search for items on the website via, for example, a search bar. A customer operating one of multiple computing devices 110, 112, 114 may access the website and perform a search for items on the website by entering in one or more terms into the search bar. In response, the website may return search results identifying one or more items, as described above and further herein. The website may allow the operator to add one or more of the items to an online shopping cart, and allow the customer to perform a “checkout” of the shopping cart to purchase the items.

Hyperparameter computing device 102 is further operable to communicate with database 116 over communication network 108. For example, hyperparameter computing device 102 can store data to, and read data from, database 116. Database 116 can be a remote storage device, such as a cloud-based server, a disk (e.g., a hard disk), a memory device on another application server, a networked computer, or any other suitable remote storage. Although shown remote to hyperparameter computing device 102, in some examples, database 116 can be a local storage device, such as a hard drive, a non-volatile memory, or a USB stick.

In some examples, database 116 stores a listing of possible hyperparameters or a hyperparameter search space that a machine learning model, such as a hyperparameter determination model, may search through for one or more machine learning models to incorporate during execution. Additionally, database 116 may store the one or more machine learning models. Further, in some examples, each possible hyperparameter may be associated with a value and/or probability, as determined by hyperparameter computing device 102 and as described further below. The value or probability can correlate with a performance of a selected hyperparameter. As such, the hyperparameter computing device 102 can utilize such value or probability to change or alter the hyperparameter configuration state of the hyperparameter determination model (e.g., change or alter one or more hyperparameter values of the hyperparameter determination model). That way, the hyperparameter determination model can improve and optimize its own capabilities in building highly performing machine learning models (e.g., to find optimal hyperparameters and corresponding configurations of such hyperparameters for particular machine learning models). In such examples, a particular hyper parameter configuration state of the hyperparameter determination model includes a particular set of hyperparameters, and each hyperparameter of the set of hyperparameters has a particular corresponding hyperparameter value.

Communication network 108 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. Communication network 108 can provide access to, for example, the Internet.

### Hyperparameter Determination

A machine learning model may be configured with (e.g., may support) various hyperparameters. For example, a machine learning model of a first type may be configurable with at least a subset of a first set of hyperparameters, and a machine learning model of a second type may be configurable with at least a subset of a second set of hyperparameters. The first set of hyperparameters and second set of hyperparameters may have overlapping hyperparameters.

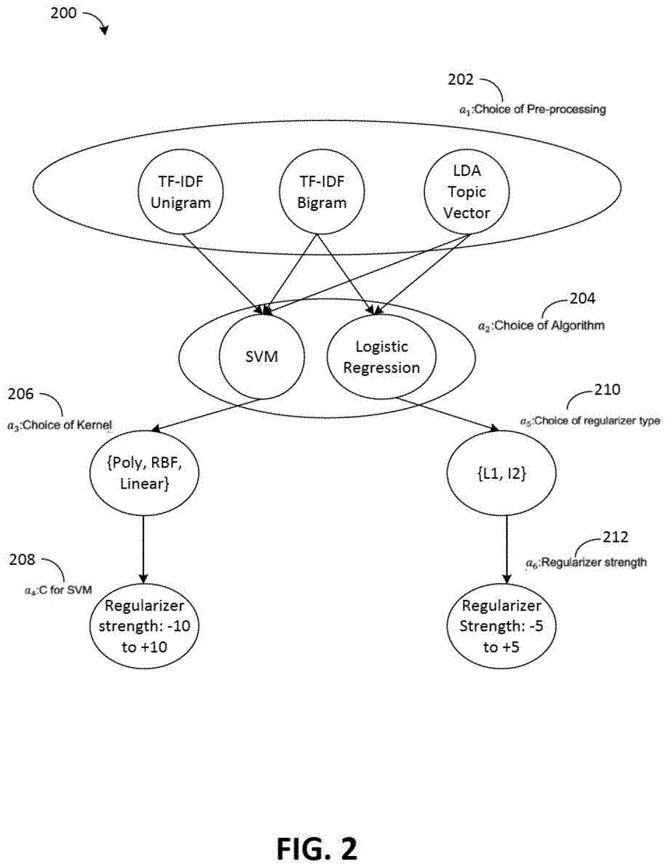

For example, FIG. 2 illustrates an example hyperparameter search space 200 that may be generated by hyperparameter computing device 102 and stored, for example, in database 116. Hyperparameter search space 200 includes various hyperparameter types 202, 204, 206, 208, 210, 212. For example, hyperparameter type a₁ 202 illustrates exemplary pre-processing hyperparameters that one or more machine learning models may be configured with. Similarly, hyperparameter type a₂ 204 illustrates exemplary algorithm hyperparameters, hyperparameter type a₃ 206 illustrates exemplary kernel hyperparameters, and hyperparameter type a₄ 208 illustrates exemplary SVM specific hyperparameters. Further, hyperparameter type a₅ 210 illustrates exemplary regularizer type hyperparameters, and hyperparameter type a₆ 212 illustrates exemplary regularizer strength hyperparameters. Each of the hyperparameter types 202, 204, 206, 208, 210, 212 includes one or more exemplary hyperparameter values.

Hyperparameter search space 200 is hierarchically organized, where edges indicate possible selections of a lower-level hyperparameter type given the selection of a higher-level hyperparameter type. For example, assuming a selection of “TF-IDF Unigram” for hyperparameter type a₁ 202, only a selection of “SVM” is available for hyperparameter type a₂ 204. In contrast, assuming a selection of “TF-IDF Bigram” for hyperparameter type a₁ 202, a selection of either “SVM” or “Logistic Regression” is available for hyperparameter type a₂ 204. Similarly, assuming a selection of “SVM” for hyperparameter type a₂, a selection of hyperparameter type a₃ 206 is available. Otherwise, if “Logistic Regression” is selected for hyperparameter type a₂, a selection of hyperparameter type a₅ 210 is available.

In some examples, hyperparameter computing device 102 determines possible hyperparameters for a given machine learning model type based on a hierarchical hyperparameter search space, such as hyperparameter search space 200.

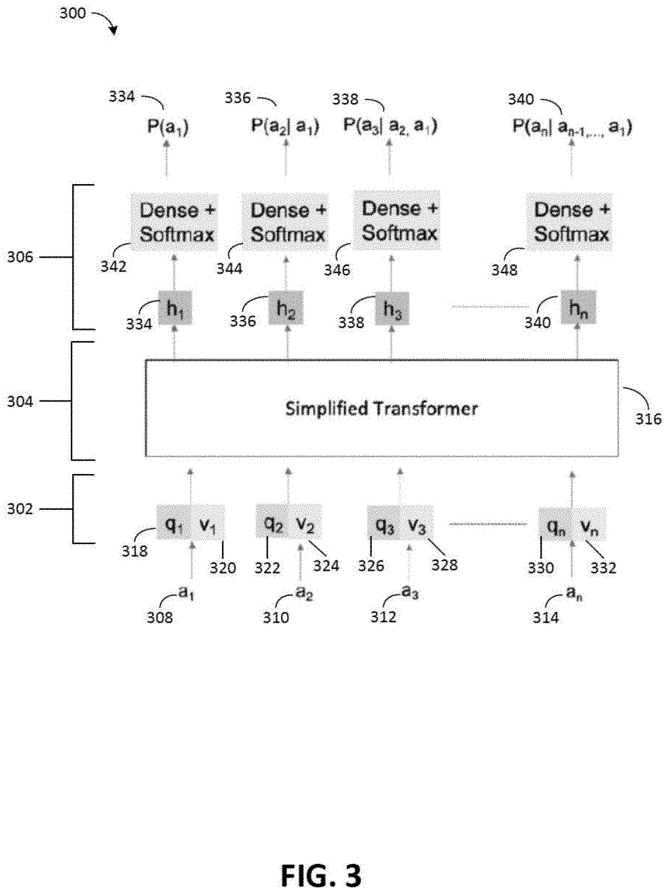

In some implementations, hyperparameter computing device 102 can utilize a hyperparameter determination model to select hyperparameters and corresponding configurations for particular machine learning models. Additionally, hyperparameter determination model can, based on the performance of the selected hyperparameters, improve such capabilities of the hyperparameter determination model. In some examples, hyperparameter determination model can determine a value corresponding to the performance of the selected hyperparameters. In such examples, the value corresponding to the performance of the selected hyperparameters can be further expressed in probabilities. FIG. 3 illustrates an example architecture of hyperparameter determination model 300 configured to map probabilities to hyperparameters according to the equation below.

$$P ( {a}_{\text{?}} , N \text{?} θ ) = {\prod }_{i = 1}^{N} P ( {a}_{\text{?}} \vert {a}_{\text{?}} θ ) \qquad ( eq . 1 )$$

$$\text{?} \text{indicates text missing or illegible when filed}$$

Additionally, hyperparameter computing device 102 may utilize the mapped probabilities to change the hyperparameter configuration state of the hyperparameter determination model 300 to improve the capabilities of the hyperparameter determination model 300.

As illustrated in FIG. 3, hyperparameter determination model 300 is in the form of a neural network with a first layer 302, a second layer 304 and a third layer 306. First layer 302 and second layer 304 can be hidden layers, while third layer 306 can be the output layer. In some implementations, first layer 302 may be configured to map hyperparameters (e.g., hyperparameters 308, 310, 312 . . . , nth hyperparameter 314) and corresponding hyperparameter values to a d dimensional vector space. In such implementations, the mapped hyperparameters were selected and validated for a particular machine learning model. Additionally, the hyperparameter values can be based on the performance data of the selected and validated hyperparameters. In some examples, first layer 302 can maintain a first vector and a second vector, such as a query vector and a value vector, of each of the selected and validated hyperparameters. For example, hyperparameter type a₁ 308 has corresponding first and second vectors 318 and 320 respectively; hyperparameter type a₂ 310 has corresponding first and second vectors 322 and 324 respectively; and hyperparameter type a₃ 312 has corresponding first and second vectors 326 and 328 respectively. Additionally, first layer 302 can be shared across all selected and validated hyperparameters.

Second layer 304 may be configured to determine or model dependencies between the mapped hyperparameters outputted from the first layer 302. For example, based on the first vector and second vector (e.g., query vector and value vector), second layer 304 can produce d dimensional contextual vectors hᵢ for each mapped hyperparameter as a function of the hyperparameter being predicted and previously seen hyperparameters according to the equation below.

hᵢ←H_{θ}(qᵢ,q_{1:i-1},v_{1:i-1}) (eq. 2)
where:
   hᵢ=d dimensional contextual vectors;
   q=query vectors; and
   v=value vectors.

In some implementations, second layer 304 can include simplified transformer 316 that includes a two-stream masked attention based architecture configured to determine or model dependencies between the mapped hyperparameters. In some examples, the two-stream masked attention based architecture comprises query and key vectors to determine He, where the query vector attends to preceding key vectors and each key vector attends to preceding key vectors as well as itself. In such examples, the first stream of the two-stream masked attention based architecture is initialized as qᵢ⁽⁰⁾←qᵢ and the second stream of the two-stream masked attention based architecture is initialized as kᵢ⁽⁰⁾←vᵢ+qᵢ (where k=key vector). Additionally, the simplified transformer can update the streams according to the equations below.

qᵢ^{(m+1)}←Tran(qᵢ^{m},k^{(m)}_{1:i-1}) (eq. 3)

kᵢ^{(m+1)}←Tran(kᵢ^{m},k^{(m)}_{1:i}) (eq. 4)
where:
   Tran is the simplified transformer; and
   Contextual representations=hᵢ←qᵢ^{M}

In addition, the computational steps of Tran can be in accordance with the equations below.

qᵢ^{(m+1)}←PosFF(qᵢ^{(m)}+Masked_Attention(Q=qᵢ^{(m)},KV=k_{1:i-1}^{(m)})) ∀i=1, . . . ,n (eq. 5)

hᵢ^{(m+1)}←PosFF(kᵢ^{(m)}+Masked_Attention(Q=kᵢ^{(m)},KV=k_{1:i}^{(m)})) ∀i=1, . . . ,n (eq. 6)

where:

PosFF(x)=W₂(tan h(W₁x+b₁))+b₂ (eq. 7)

Third layer 306 may be configured to compute or determine a probability density for each mapped hyperparameter based on the d dimensional contextual representations of each mapped hyperparameter that was outputted by the second layer 304. In some examples, third layer 306 can include a “softmax” function to determine the probability densities for each mapped hyperparameter (e.g., softmax engine 342, 344, 346 . . . , 348ₙ). For example, third layer 306 may determine the probability density for each mapped hyperparameter according to the equation below:

$$P ( {a}_{i} \vert {a}_{1 ; i - \text{?}} ; θ ) = \frac{exp ( {h}_{\text{?}}^{T} {W}_{\text{?}}^{i} + {b}_{\text{?}}^{i} )}{{\sum }_{j} exp ( {h}_{j}^{T} {W}_{j}^{i} + {b}_{j}^{i} )} \qquad ( eq . 8 )$$

$$\text{?} \text{indicates text missing or illegible when filed}$$

As illustrated in FIG. 3, based on the d dimensional contextual representation of each mapped hyperparameter, hyperparameter type a₁ 308 has corresponding first probability 334; hyperparameter type a₂ 310 has corresponding second probability 336; and hyperparameter type a₃ 312 has corresponding third probability 340.

In various implementations, the hyperparameter computing device 102 can optimize the training of hyperparameter determination model for the objective function, J′(0) according to the equation below.

$${J}^{′} ( θ ) = {𝔼}_{{a}_{1 : N} ∼ P ( {a}_{1 : N {\text{?}}^{θ}} )} \text{?} A ( {a}_{1 : N} ) min ( r ( {a}_{1 : N} ; θ , {θ}^{′} ) , \qquad ( eq . 9 )$$

$$clip ( r ( {a}_{1 : N} ; θ , {θ}^{′} ) , 1 - ϵ , 1 + ϵ ) ) ]$$

$$r ( {a}_{1 : N} ; θ , {θ}^{′} ) = \frac{P ( {a}_{1 : N} ; θ )}{P ( {a}_{1 : N} ; {θ}^{′} )} \qquad ( eq . 10 )$$

$$where$$

$$\text{?} \text{indicates text missing or illegible when filed}$$

Additionally, hyperparameter computing device 102 can update the hyperparameter determination model via gradient descent in accordance with the equation below

θ←θ+α∇J′(θ) (eq. 11)

Moreover, hyperparameter computing device 102 can reduce the variance of the hyperparameter determination model using the equation below.

V_{θ}(a_{≤i})= [symbol] ₐ_{_{i+1:N}}_{˜P(a}_{_{i+1:N}}_{|a}_{_{≤i}}_{:θ)}[f(a_{1:N})] (eq. 12)

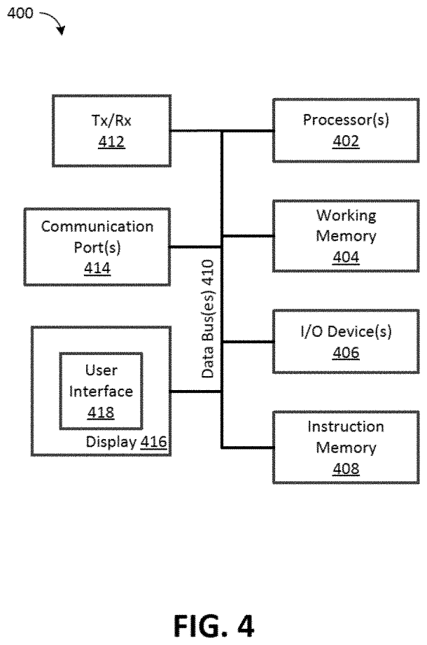

FIG. 4 illustrates a block diagram of example hyperparameter computing device 102 of FIG. 1. Hyperparameter computing device 102 can include one or more processors 402, working memory 404, one or more input/output devices 406, instruction memory 408, a transceiver 412, one or more communication ports 414, and a display 416, all operatively coupled to one or more data buses 410. Data buses 410 allow for communication among the various devices. Data buses 410 can include wired, or wireless, communication channels.

Processors 402 can include one or more distinct processors, each having one or more cores. Each of the distinct processors can have the same or different structure. Processors 402 can include one or more central processing units (CPUs), one or more graphics processing units (GPUs), application specific integrated circuits (ASICs), digital signal processors (DSPs), and the like.

Instruction memory 408 can store instructions that can be accessed (e.g., read) and executed by processors 402. For example, instruction memory 408 can be a non-transitory, computer-readable storage medium such as a read-only memory (ROM), an electrically erasable programmable read-only memory (EEPROM), flash memory, a removable disk, CD-ROM, any non-volatile memory, or any other suitable memory. Processors 402 can be configured to perform a certain function or operation by executing code, stored on instruction memory 408, embodying the function or operation. For example, processors 402 can be configured to execute code stored in instruction memory 408 to perform one or more of any function, method, or operation disclosed herein.

Additionally, processors 402 can store data to, and read data from, working memory 404. For example, processors 402 can store a working set of instructions to working memory 404, such as instructions loaded from instruction memory 408. Processors 402 can also use working memory 404 to store dynamic data created during the operation of hyperparameter computing device 102. Working memory 404 can be a random access memory (RAM) such as a static random access memory (SRAM) or dynamic random access memory (DRAM), or any other suitable memory.

Input/output devices 406 can include any suitable device that allows for data input or output. For example, input/output devices 406 can include one or more of a keyboard, a touchpad, a mouse, a stylus, a touchscreen, a physical button, a speaker, a microphone, or any other suitable input or output device.

Communication port(s) 414 can include, for example, a serial port such as a universal asynchronous receiver/transmitter (UART) connection, a Universal Serial Bus (USB) connection, or any other suitable communication port or connection. In some examples, communication port(s) 414 allows for the programming of executable instructions in instruction memory 408. In some examples, communication port(s) 414 allow for the transfer (e.g., uploading or downloading) of data, such as hyperparameter data.

Display 416 can display user interface 418. User interface 418 can enable user interaction with hyperparameter computing device 102. For example, user interface 418 can be a user interface for an application of a retailer that allows a customer to view and interact with a retailer's website. In some examples, a user can interact with user interface 418 by engaging input/output devices 406. In some examples, display 416 can be a touchscreen, where user interface 418 is displayed on the touchscreen.

Transceiver 412 allows for communication with a network, such as the communication network 108 of FIG. 1. For example, if communication network 108 of FIG. 1 is a cellular network, transceiver 412 is configured to allow communications with the cellular network. In some examples, transceiver 412 is selected based on the type of communication network 108 hyperparameter computing device 102 will be operating in. Processor(s) 402 is operable to receive data from, or send data to, a network, such as communication network 108 of FIG. 1, via transceiver 412.

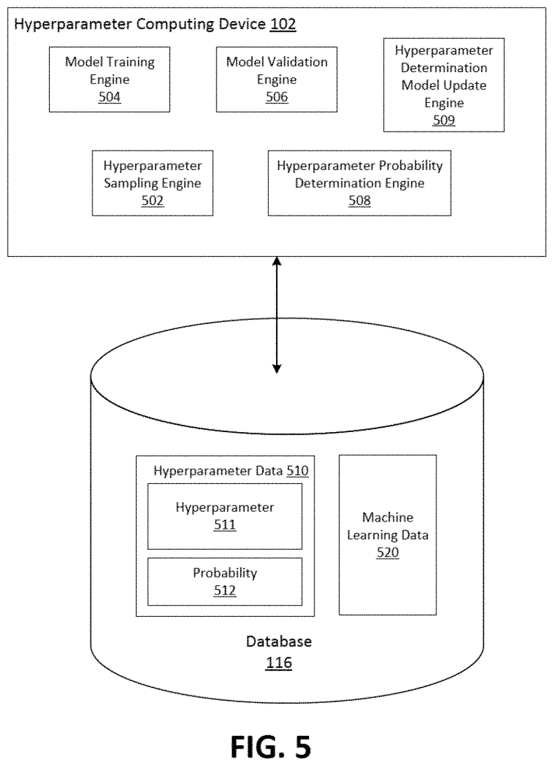

FIG. 5 is a block diagram illustrating examples of various portions of the hyperparameter computing device 102. As illustrated in FIG. 5, hyperparameter computing device 102 can include a hyperparameter sampling engine 502, model training engine 504, model validation engine 506, hyperparameter probability determination engine 508, and hyperparameter determination model update engine 509. In some examples, one or more of hyperparameter sampling engine 502, model training engine 504, model validation engine 506, hyperparameter probability determination engine 508, and hyperparameter determination model update engine 509 may be implemented in hardware. In some examples, one or more of hyperparameter sampling engine 502, model training engine 504, model validation engine 506, hyperparameter probability determination engine 508, and hyperparameter determination model update engine 509 may be implemented as an executable program maintained in a tangible, non-transitory memory, such as instruction memory 408 of FIG. 4, that may be executed by one or processors, such as processor 402 of FIG. 4.

Additionally, in various implementations, database 116 of FIG. 5, may store machine learning model data 520 identifying and characterizing one or more machine learning models. Database 116 may further store hyperparameter data 510, which may identify a search space, such as hyperparameter search space 200. The search space may include a plurality of hyperparameter types and corresponding hyperparameter 511 for each hyperparameter type.

Hyperparameter computing device 102 may leverage a hyperparameter determination model stored in database 116 to determine and select hyperparameters 511 for one or more of the machine learning models. Additionally, hyperparameter computing device 102 may be configured to improve the performance and capabilities of the hyperparameter determination model based on the performance of the selected hyperparameters 511.

In some implementations, hyperparameter sampling engine 502 is configured to determine a set of hyperparameters comprising at least a portion of hyperparameters 511 from database 116. In examples where a particular machine learning model is to be initially configured, hyperparameter sampling engine 502 can randomly select the set of hyperparameters. In examples where hyperparameters of a particular machine learning model are being fine-tuned or optimized, hyperparameter sampling engine 502 may select the set of hyperparameters based on corresponding probabilities 512. Such probabilities can be determined by hyperparameter probability determination engine 508 utilizing a hyperparameter determination model, such as hyperparameter determination model 300. Additionally, hyperparameter sampling engine 502 may provide the set of hyperparameters to model training engine 504.

Model training engine 504 can be configured to train one or more machine learning models, such as a machine learning model identified by machine learning model data 520. Additionally, model training engine 504 can train one or more learning models configured with the set of hyperparameters obtained from hyperparameter sampling engine 502. For example, model training engine 504 may obtain a machine learning model from machine learning model data 520 stored in database 116, and train the configured machine learning model with a training dataset. Model training engine 504 may provide the trained and configured machine learning model to model validation engine 506.

Model validation engine 506 may execute the trained and configured machine learning model to determine performance data or information, such as a validation score or value, for each hyperparameter of the set of hyperparameters. For example, model validation engine 506 may provide validation data as input to the trained machine learning model, and execute the trained machine learning model to generate output results. Model validation engine 506 may then compare the output results to expected results (e.g., which may be stored in database 116), and determine the validation score or value based on the comparison. For example, the validation score may be an Fi score based on the output results and the expected results. Model validation engine 506 may provide, to hyperparameter probability determination engine 508, performance data including information indicating the determined validation score or value.

Based on the performance data, hyperparameter probability determination engine 508 may utilize a hyperparameter determination model to determine one or more probability densities or probabilities 512 for one or more hyperparameters 511 of the set of hyperparameters, according to equation 1. As a result, hyperparameter probability determination engine 508 may assign higher probabilities to hyperparameters (e.g., hyperparameter types) that yield higher validation scores. Hyperparameter probability determination engine 508 may store and/or update the probabilities in database 116. Hyperparameter probability determination engine 508 may provide the probabilities 512 of each hyperparameter of the set of hyperparameters to hyperparameter determination model update engine 509.

Hyperparameter determination model update engine 509 may utilize the updated probabilities 512 of each hyperparameter of the set of hyperparameters to change or alter the hyperparameter configuration state of the hyperparameter determination model. For example, based on probability 512 of each hyperparameter of the set of hyperparameters, hyperparameter determination model update engine 509 determine which hyperparameters and corresponding configurations of the hyperparameter determination model resulted in hyperparameters of the set of hyperparameters with higher and/or lower probabilities. Additionally, based on such determinations, the hyperparameter determination model update engine 509 may change or adjust a hyperparameter configuration state (e.g., change one or more hyperparameter configurations) of the hyperparameter determination model. For instance, hyperparameter determination model update engine 509 determines one or more hyperparameter configurations of the hyperparameter determination model resulted in the selection of a first hyperparameter with a particular configuration that yielded a lower probability. As such, hyperparameter determination model update engine 509 may adjust or change the one or more hyperparameter configurations of the hyperparameter determination model to increase the likelihood that the hyperparameter determination model, going forward, would likely select another hyperparameter that may yield a higher probability or reselect the first hyperparameter with a different configuration that may yield a higher probability.

Additionally, hyperparameter sampling engine 502 may utilize the reconfigured hyperparameter determination model to resample the hyperparameters 511 based on the updated probabilities 512. In various implementations, hyperparameter computing device 102 can continue refining the machine learning model and/or the hyperparameter determination model in accordance with the above process until a final set of hyperparameters have been determined. For example, hyperparameter determination computing device 102 may continue the above process until one or more conditions are satisfied. A condition may include, for example, a computational resource limitation, such as a computational budget. In some examples, the computational budget can be expressed monetarily. In other examples, the computational budget can be expressed as a predetermined number of sampling/resampling cycles.

### Methodology

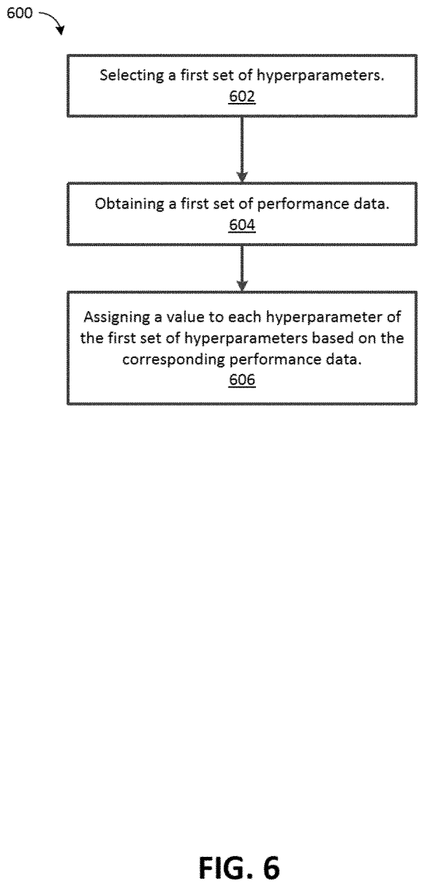

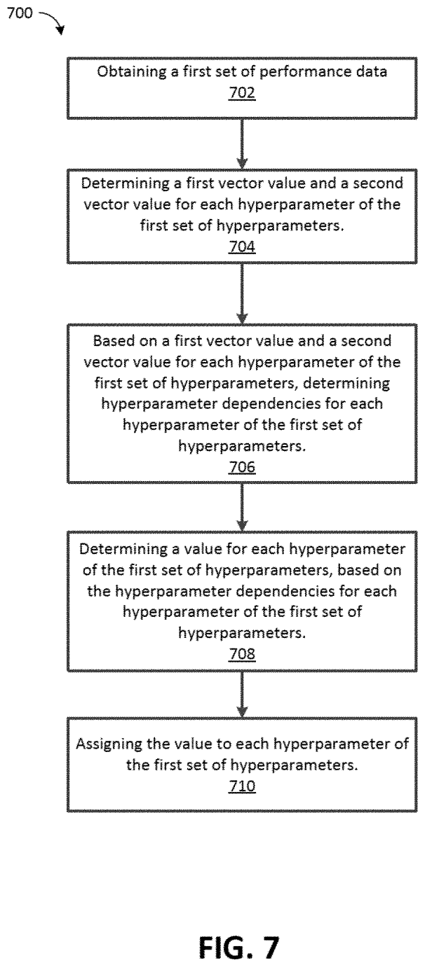

FIG. 6 illustrates an example method that can be carried out by the hyperparameter computing device 102. FIG. 7 illustrates another example method that can be carried out by the hyperparameter computing device 102. In describing an example method of FIGS. 6 and 7, reference is made to elements of FIGS. 1, 3 and 4 for purpose of illustrating a suitable component for performing a step or sub-step being described.

With reference to example method 600 of FIG. 6, hyperparameter computing device 102 may select a first set of hyperparameters (602). In some examples, hyperparameter sampling engine 502 may utilize hyperparameter determination model, such as hyperparameter determination model 300, to select the first set of hyperparameters for a particular machine learning model. In such examples, the hyperparameter sampling engine 502 may implement a first set of hyperparameter search operations to sample and select the first set of hyperparameters. Additionally, the hyperparameter sampling engine 502 may select the first set of hyperparameters based on a corresponding probability of each of the first set of hyperparameters. Moreover, the hyperparameter determination model may be sampling and selecting the first set of hyperparameters while in a particular or first configuration state.

Additionally, hyperparameter computing device 102 may obtain a first set of performance data. The first set of performance data includes information indicating a performance of each hyperparameter of the first set of hyperparameters. In some examples, hyperparameter sampling engine 502 may provide the set of hyperparameters to model training engine 504. Model training engine 504 can configure the particular machine learning model with the obtained first set of hyperparameters and train the configured machine learning model with a training dataset. Additionally, model validation engine 506 may execute the trained and configured machine learning model to determine performance data or information, such as a validation score or value, for each hyperparameter of the set of hyperparameters.

Furthermore, hyperparameter computing device 102 may assign a value to each hyperparameter of the first set of hyperparameters based on the corresponding performance data. For example, hyperparameter probability determination engine 508 can utilize the performance data to determine a probability density or probability 512 for each hyperparameter of the first set of hyperparameters according to equation 1. Additionally, hyperparameter determination model update engine 509 may utilize the determined probability 512 of each hyperparameter of the first set of hyperparameters to change or alter the hyperparameter configuration state of the hyperparameter determination model. For example, based on the determined probability 512 of each hyperparameter of the first set of hyperparameters, hyperparameter determination model update engine 509 can determine which hyperparameters and corresponding configurations of the hyperparameter determination model resulted in hyperparameters of the set of hyperparameters with higher and/or lower probabilities. Additionally, based on such determinations, the hyperparameter determination model update engine 509 may change or adjust a hyperparameter configuration state (e.g., change one or more hyperparameter configurations) of the hyperparameter determination model. That way, going forward, the hyperparameter determination model can better select hyperparameters for a particular machine learning model (e.g., configure the hyperparameters of the hyperparameter determination model so that it will select a higher proportion of hyperparameters that would yield a higher probability than its previous hyperparameter configuration state).

In various implementations, hyperparameter computing device 102 can take into account a computational resource limitation, before implementing a second or next set of hyperparameter search operations to sample and select the first set of hyperparameters. In some examples, the computational budget can be expressed in monetarily. In other examples, the computational budget can be expressed as a predetermined number of sampling/resampling cycles.

For example, before hyperparameter computing device 102 initializes another set of hyperparameter search operations, hyperparameter computing device 102 can determine a state of computational resource limitation, such as a computational budget. In examples where the computational budget is a predetermined number of sampling/resampling cycles, hyperparameter computing device 102 can determine whether the next sampling cycle will cause the total number of sampling cycles to equal the predetermined number of sampling cycles. If so, then hyperparameter computing device 102 can prevent the next set of hyperparameter search operations from initializing. Otherwise, hyperparameter computing device 102 can continue with initializing the next hyperparameter search operation.

In examples where the computational budget is expressed monetarily, hyperparameter computing device 102 can determine whether the next sampling cycle will cause the total cost of running these cycles to equal a predetermined cost threshold. If so, then hyperparameter computing device 102 can prevent the next set of hyperparameter search operations from initializing. Otherwise, hyperparameter computing device 102 can continue with initializing the next hyperparameter search operation.

With reference to example method 700 of FIG. 7, hyperparameter computing device 102 may obtain a first set of performance data (702). The first set of performance data includes information indicating a performance of each hyperparameter of the first set of hyperparameters. Additionally, hyperparameter computing device 102 may determine a first vector value and a second vector value for each hyperparameter of the first set of hyperparameters (704). In some examples, based on the performance data of the first set of hyperparameters, hyperparameter computing device 102 can utilize a hyperparameter determination model, such as hyperparameter determination model 300, to map each hyperparameter of the first set of hyperparameters (e.g., hyperparameters 308, 310, 312 . . . , nth hyperparameter 314) and corresponding hyperparameter validation scores to a d dimensional vector space. In some examples, the hyperparameter determination model can maintain a first vector and a second vector, such as a query vector and a value vector, of each of the selected and validated hyperparameters.

Moreover, hyperparameter computing device 102 may determine hyperparameter dependencies for each hyperparameter of the first set of hyperparameters, based on the first vector and the second vector (706). In some examples, hyperparameter computing device 102 can utilize a simplified transformer with a two-stream masked attention based architecture to determine such hyperparameter dependencies.

Furthermore, hyperparameter computing device 102 may determine a value for each hyperparameter of the first set of hyperparameters, based on the hyperparameter dependencies for each hyperparameter of the first set of hyperparameters (708). In some examples, hyperparameter computing device 102 may determine a value, such as a probability density, for each hyperparameter of the first set of hyperparameters according to equation 8.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The term model as used in the present disclosure includes data models created using machine learning. Machine learning may involve training a model in a supervised or unsupervised setting. Machine learning can include models that may be trained to learn relationships between various groups of data. Machine learned models may be based on a set of algorithms that are designed to model abstractions in data by using a number of processing layers. The processing layers may be made up of non-linear transformations. The models may include, for example, artificial intelligence, neural networks, deep convolutional and recurrent neural networks. Such neural networks may be made of up of levels of trainable filters, transformations, projections, hashing, pooling and regularization. The models may be used in large-scale relationship-recognition tasks. The models can be created by using various open-source and proprietary machine learning tools known to those of ordinary skill in the art.

The foregoing is provided for purposes of illustrating, explaining, and describing embodiments of these disclosures. Modifications and adaptations to these embodiments will be apparent to those skilled in the art and may be made without departing from the scope or spirit of these disclosures.

What is claimed is:

1. A system comprising:
one or more processors;
a set of memory resources to store a set of instructions that when executed by the one or more processors cause the system to:
implement, in a first hyperparameter configuration state, a first set of hyperparameter search operations, the first set of hyperparameter search operations including:
selecting a first set of hyperparameters, each hyperparameter of the first set of hyperparameters having a corresponding configuration;
obtaining a first set of performance data, the first set of performance data including information indicating a performance of each hyperparameter of the first set of hyperparameters; and
assigning a value to each hyperparameter of the first set of hyperparameters based on the first set of performance data.

2. The system of claim 1, wherein execution of the set of instructions, by the one or more processors, that cause the system to assign a value to each hyperparameter of the first set of hyperparameters, further causes the system to:
determining a first vector value and a second vector value for each hyperparameter of the first set of hyperparameters by mapping each hyperparameter of the first set of hyperparameters and corresponding assigned value.

3. The system of claim 2, wherein execution of the set of instructions, by the one or more processors, that cause the system to assign a value to each hyperparameter of the first set of hyperparameters, further causes the system to:
based on a first vector value and a second vector value for each hyperparameter of the first set of hyperparameters, determining hyperparameter dependencies for each hyperparameter of the first set of hyperparameters by utilizing a simplified transformer with a two-stream masked attention based architecture.

4. The system of claim 3, wherein execution of the set of instructions, by the one or more processors, that cause the system to assign a value to each hyperparameter of the first set of hyperparameters, further causes the system to:
determining the value for each hyperparameter of the first set of hyperparameters, based on the hyperparameter dependencies for each hyperparameter of the first set of hyperparameters.

5. The system of claim 4, wherein the value is a probability density.

6. The system of claim 1, wherein execution of the set of instructions, by the one or more processors, further cause the system to:
based on the assigned value of each hyperparameter of the first set of hyperparameters, alter the hyperparameter configuration state into a second hyperparameter configuration state; and
implement, in a second hyperparameter configuration state, a second set of hyperparameter search operations.

7. The system of claim 6, wherein execution of the set of instructions, by the one or more processors, further cause the system to:
determine a state of a computational resource limitation; and
based on the determined state of the computational resource limitation, determine whether to initialize the second set of hyperparameter search operations.

8. The system of claim 7, wherein execution of the set of instructions, by the one or more processors, that cause the system to determine to initialize the second set of hyperparameter search operations is based on determining the computational resource limitation is in a first state.

9. The system of claim 1, wherein the first set of performance data is generated based on cross-validation techniques.

10. The system of claim 1, wherein the first set of hyperparameters are selected randomly.

11. A computer-implemented method comprising:
implementing, in a first hyperparameter configuration state, a first set of hyperparameter search operations, the first set of hyperparameter search operations including:
selecting a first set of hyperparameters, each hyperparameter of the first set of hyperparameters having a corresponding configuration;
obtaining a first set of performance data, the first set of performance data including information indicating a performance of each hyperparameter of the first set of hyperparameters; and
assigning a value to each hyperparameter of the first set of hyperparameters based on the first set of performance data.

12. The computer-implemented method of claim 11, wherein assigning a value to each hyperparameter of the first set of hyperparameters includes:
determining a first vector value and a second vector value for each hyperparameter of the first set of hyperparameters by mapping each hyperparameter of the first set of hyperparameters and corresponding assigned value.

13. The computer-implemented method of claim 12, wherein assigning a value to each hyperparameter of the first set of hyperparameters includes:
based on a first vector value and a second vector value for each hyperparameter of the first set of hyperparameters, determining hyperparameter dependencies for each hyperparameter of the first set of hyperparameters by utilizing a simplified transformer with a two-stream masked attention based architecture.

14. The computer-implemented method of claim 13, wherein assigning a value to each hyperparameter of the first set of hyperparameters includes:
determining the value for each hyperparameter of the first set of hyperparameters, based on the hyperparameter dependencies for each hyperparameter of the first set of hyperparameters.

15. The computer-implemented method of claim 14, wherein the value is a probability density.

16. The computer-implemented method of claim 11, further comprising:
based on the assigned value of each hyperparameter of the first set of hyperparameters, changing the hyperparameter configuration state into a second hyperparameter configuration state; and
implementing, in a second hyperparameter configuration state, a second set of hyperparameter search operations.

17. The computer-implemented method of claim 16, further comprising:
determining a state of a computational resource limitation; and
based on the determined state of the computational resource limitation, determining whether to initialize the second set of hyperparameter search operations.

18. The computer-implemented method of claim 17, wherein determining to initialize the second set of hyperparameter search operations is based on determining the computational resource limitation is in a first state.

19. The computer-implemented method of claim 11, wherein the first set of hyperparameters are selected randomly.

20. A non-transitory computer readable medium having instructions stored thereon, wherein the instructions, when executed by one or more processors, cause a system to:
implement, in a first hyperparameter configuration state, a first set of hyperparameter search operations, the first set of hyperparameter search operations including:
selecting a first set of hyperparameters, each hyperparameter of the first set of hyperparameters having a corresponding configuration;
obtaining a first set of performance data, the first set of performance data including information indicating a performance of each hyperparameter of the first set of hyperparameters; and
assigning a value to each hyperparameter of the first set of hyperparameters based on the first set of performance data.
